(19) United States
(12) Patent Application Publication
(10) Pub. No.: US 2014/0098249 A1
(43) Pub. Date: Apr. 10, 2014

(54) TERMINAL, METHOD OF FORMING VIDEO, APPARATUS TO FORM AN IMAGE, DRIVING METHOD THEREOF, AND COMPUTER-READABLE RECORDING MEDIUM

(71) Applicant: Samsung Electronics Co., Ltd., Suwon-si (KR)

(72) Inventor: Jeong-jin PARK, Suwon-si (KR)

(73) Assignee: Samsung Electronics Co., Ltd., Suwon-si (KR)

(21) Appl. No.: 13/934,308

(22) Filed: Jul. 3, 2013

(30) Foreign Application Priority Data
Oct. 5, 2012 (KR) 10-2012-0110867

(51) Int. Cl. H04N 1/00

(52) U.S. Cl. CPC H04N 1/00278; H04N 1/00251
USPC 348/207.2

(57) ABSTRACT

A terminal, an image forming method, an image forming apparatus, a method of driving the image forming apparatus, and a computer-readable recording medium including a program to execute the method are provided. The terminal includes: a location information sensor which acquires location information about a current location of the terminal; a data processor which receives location information of a nearby image forming apparatus based on the current location and calculates a relative location coordinate of the nearby image forming apparatus by using the received location information and the location information of the current location; and an interface which overlays and outputs an icon of the nearby image forming apparatus on an image captured through an imaging part, based on a coordinate value of the calculate relative location coordinate.

### CROSS-REFERENCE TO RELATED APPLICATIONS

This application claims priority under 35 U.S.C. §119 from Korean Patent Application No. 10-2012-110867, filed on Oct. 5, 2012, in the Korean Intellectual Property Office, the disclosure of which is incorporated herein by reference in its entirety.

### BACKGROUND OF THE INVENTION

1. Field of the Invention

The present general inventive concept generally relates to a terminal, a method of forming a video, an apparatus to form an image, a driving method thereof, and a computer-readable recording medium, and more particularly, to a terminal which matches location and state information of a mobile image forming apparatus on an image captured by using the terminal, the image forming apparatus, an image forming method, a method of driving the image forming apparatus, and a computer-readable recording medium including a program to execute such method.

2. Description of the Related Art

Smart phones and tablet personal computers (PCs) are the latest craze to sweep the world. They have changed consumer habits and life patterns. Information Technology (IT) devices are closely connected to our daily lives. This is because anyone can easily use the new technology. A representative new technology is an augmented reality (AR).

The AR refers to an image technology which is internally complicated but basically operates according to the following principles. There is required a global positioning system (GPS) apparatus and a gravity sensor which transmit and receive geography and location information, storage means which stores the geography and location information, an AR application which receives the detailed information and displays the information on a real background, and an IT device which outputs this information to a display.

If a user executes the AR application and then focuses on a particular street or building through an internal camera of a smart phone, latitude and longitude information of a current location, gradient and gravity information, etc. are temporarily stored in the smart phone through a GPS receiver. This GPS information is transmitted to a particular GPS through the Internet. This is because it is not realistic to permanently store all of the detailed information of a district or building within a corresponding location radius in the smart phone.

If the GPS receives the GPS information, such as the location and gradient information, from the user, the GPS searches a database (DB) thereof for detailed information of a corresponding district or object and then transmits the search result to the smart phone. Here, the detailed information includes the building name, phone number, etc. of a particular building. If the smart phone receives the detailed information, the smart phone matches the detailed information with current map information through the AR application and then displays the matched result on a screen in real time. The above-described data transmission and reception operation is continuously kept and performed. Therefore, if the user goes by a street with the smart phone, detailed information of a corresponding district and the surrounding is sequentially displayed on the screen.

However, a conventional AR application technology simply displays static information and a fixed object. The object being displayed does not update information by itself. Instead, a manager separately inputs data about the object to provide the corresponding information.

### SUMMARY OF THE INVENTION

Exemplary embodiments address at least the above problems and/or disadvantages and other disadvantages not described above. Also, the exemplary embodiments are not required to be directed to simply overcoming the disadvantages described above, and exemplary embodiments may be directed to other features other than overcoming the problems described above.

The exemplary embodiments provide a terminal which matches location and state information of a mobile image forming apparatus on an image captured by using the terminal. The exemplary embodiments also provide the image forming apparatus, an image forming method, a method of driving the image forming apparatus, and a computer-readable recording medium including a program to execute such a method.

Additional features and utilities of the present general inventive concept will be set forth in part in the description which follows and, in part, will be obvious from the description, or may be learned by practice of the general inventive concept.

Exemplary embodiments of the present inventive concept provide a terminal including: a location information sensor which acquires location information about a current location of the terminal; a data processor which receives location information of a nearby image forming apparatus based on the current location of the terminal and calculates a relative location coordinate of the nearby image forming apparatus by using the received location information of the nearby image forming apparatus and the location information of the current location of the terminal; and an interface which overlays and outputs an icon of the nearby image forming apparatus on an image captured through an imaging part, based on a coordinate value of the calculated relative location coordinate.

The terminal may further include a searcher which searches for the image forming apparatus. The data processor may receive location information about the searched image forming apparatus.

The terminal may further include a direction information sensor which acquires direction information of the terminal. The interface may overlay the icon on the image by additionally using the direction information.

The data processor may receive location information stored in the image forming apparatus or location information provided when accessing an external service apparatus which stores location information of the image forming apparatus.

The interface may include and output status information of the image forming apparatus in the icon.

Exemplary embodiments of the present inventive concept also provide an image forming apparatus including: a location information sensor which acquires location information about a current location of the image forming apparatus; and a controller which, if a terminal requests the location information to overlay and display an icon of the image forming apparatus on an image captured through an imaging part, controls the location information sensor to provide the location information according to the request.

The image forming apparatus may further include a status information manager which stores status information of the image forming apparatus and provides the status information according to a request of the terminal.

The status information manager may store at least one of a residual amount of toner, error information, and an operation status as the status information of the image forming apparatus.

The controller may periodically check a status of the image forming apparatus to update the status information stored in the status information manager.

The location information sensor may include a global positioning system (GPS) communication module which is to communicate with a GPS. The location information sensor may periodically check the status information of the image forming apparatus, which is changed, through the GPS communication module.

The location information sensor may include a near field communication module which is to communicate with nearby access points (APs). The location information sensor may measure the nearby APs according to a triangulation by using locations and signal intensities of the nearby APs acquired through the near field communication module to acquire the location information.

Exemplary embodiments of the present inventive concept also provide an image forming method of a terminal. The image forming method may include: acquiring location information about a current location of the terminal; receiving location information of an image forming apparatus near the terminal and calculating a relative location coordinate of the image forming apparatus by using the location information of the image forming apparatus and the location information of the terminal; acquiring an image through an imaging part of the terminal; and overlaying and outputting an icon of the image forming apparatus on the acquired image based on a coordinate value of the calculated relative location coordinate.

The image forming method may further include: searching for the image forming apparatus. The location information of the image forming apparatus may be received to calculate the relative location coordinate.

The image forming method may further include: acquiring direction information of the terminal. The icon may be overlaid on the acquired image by additionally using the direction information.

Location information stored in the image forming apparatus may be received or an external service apparatus storing the location information of the image forming apparatus may be accessed to receive location information in order to calculate the relative location coordinate.

The overlaying of the icon may include: including and outputting status information of the image forming apparatus in the icon.

Exemplary embodiments of the present inventive concept also provide a method of driving an image forming apparatus. The method may include: acquiring location information about a current location of a location information sensor; and if a terminal requests the location information to overlay and display an icon of the image forming apparatus on an image acquired through an imaging part, controlling the location information sensor to provide the location information according to the request.

The method may further include: storing status information of the image forming apparatus in a status information storage and providing the stored status information according to a request of the terminal.

The status information storage may store at least one of a residual amount of toner, error information, and an operation status as the status information of the image forming apparatus.

A controller may periodically check a status of the image forming apparatus to update the status information stored in the status information storage.

The location information sensor may communicate with a GPS by using a GPS communication module. The location information sensor may periodically check the location information of the image forming apparatus through the GPS communication module.

The location information sensor may communicate nearby APs by using a near field communication module. The location information sensor may measure the nearby APs according to a triangulation by using locations and signal intensities of the nearby APs acquired through the near field communication module to acquire the location information.

Exemplary embodiments of the present inventive concept also provide a non-transitory computer-readable recording medium comprising a program to execute the image forming method.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating an image forming system according to an exemplary embodiment of the present general inventive concept;

FIG. 2 is a view illustrating a user interface (UI) displayed on a terminal of FIG. 1, according to an exemplary embodiment of the present general inventive concept;

FIG. 3 is a block diagram illustrating a structure of the terminal of FIG. 1, according to an exemplary embodiment of the present general inventive concept;

FIG. 4 is a block diagram illustrating a structure of an image forming apparatus of FIG. 1, according to an exemplary embodiment of the present general inventive concept;

FIG. 5 is a block diagram illustrating a structure of a service apparatus of FIG. 1, according to an exemplary embodiment of the present general inventive concept;

FIG. 6 is a flowchart illustrating a process of forming an image according to an exemplary embodiment of the present general inventive concept;

FIG. 7 is a view illustrating a data flow if the service apparatus of FIG. 1 is used, according to an exemplary embodiment of the present general inventive concept;

FIG. 8 is a flowchart illustrating operations performed between a terminal and a service apparatus according to an exemplary embodiment of the present general inventive concept;

FIG. 9 is a flowchart illustrating operations performed between a terminal and an image forming apparatus according to an exemplary embodiment of the present general inventive concept;

FIG. 10 is a view illustrating a data flow if the service apparatus of FIG. 1 is not used, according to an exemplary embodiment of the present general inventive concept;

FIG. 11 is a flowchart illustrating an image forming method according to an exemplary embodiment of the present general inventive concept;

FIG. 12 is a flowchart illustrating an image forming method according to another exemplary embodiment of the present general inventive concept;

FIG. 13 is a flowchart illustrating a method of driving the image forming apparatus of FIG. 1, according to an exemplary embodiment of the present general inventive concept;

FIG. 14 is a flowchart illustrating a method of driving the service apparatus of FIG. 1, according to an exemplary embodiment of the present general inventive concept; and

FIG. 15 is a view illustrating a screen embodied in the terminal of FIG. 1, according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

In the following detailed description of exemplary embodiments, a terminal according to an exemplary embodiment of the present inventive concept may be referred to as a mobile device, an image forming apparatus may be referred to as a printer, and a service apparatus may be referred to as a printer server, but the present general inventive concept is not limited thereto.

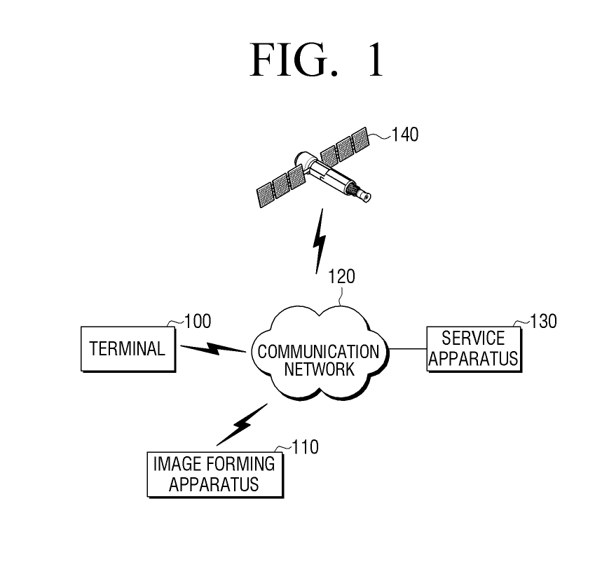

FIG. 1 is a view illustrating an image forming system according to an exemplary embodiment of the present general inventive concept.

Referring to FIG. 1, the image forming system includes some or all of a terminal 100, one or more image forming apparatuses 110, a communication network 120, a service apparatus 130, and a part or whole of a navigation apparatus 140.

It will be understood that some elements such as the service apparatus 130 or the navigation apparatus 140 may be omitted to constitute the image forming system, or some elements may be integrated with other elements to constitute the image forming system. The components are described separately herein to convey a sufficient understanding of the present general inventive concept.

Examples of the terminal 100 include a desktop computer, as well as a mobile communication terminal such as a smart phone, a notebook computer, a tablet personal computer (PC), a personal digital assistant (PDA), and so on. The terminal 100 may include near field communication modules for performing near field communications, such as a global positioning system (GPS) communication module and Wi-Fi for communicating with the navigation apparatus 140. Based off of information received through the near field communication modules, the terminal 100 calculates its current location, stores the calculated location information in an internal memory, and transmits the calculated location information to the service apparatus 130. The terminal 100 may also include a camera, a location sensor, and a direction measuring sensor. The camera, the location sensor, and the direction measuring sensor, also give the terminal 100 location information. Through the communication network 120, the terminal 100 transmits the location information to the service apparatus 130 and receives image forming information from the service apparatus 130. The terminal 100 then performs data processing for mapping the image forming information on a user interface (UI) screen to display the image forming information to a user.

For example, the terminal 100 according to the present exemplary embodiment realizes an image in which an icon of the image forming apparatus 110 is overlaid on an image captured through an imaging part, e.g., the camera. In other words, if the camera is operated to capture an image of the image-forming apparatus, and an icon corresponding to the image forming apparatus 100 is displayed on a screen of the terminal 100. Here, status (or state) information of the image forming apparatus 100 may be displayed together on the overlaid icon. The status information refers to a residual amount of toner, an operation status of the image forming apparatus, or the like. In order to realize an image as described above, the user of the terminal 100 executes a mobile application (hereinafter referred to as an app) which is pre-stored and released in the manufacture of the terminal 100 or downloaded and installed from the service apparatus 130.

When executing the app as described above, through the network 120 the terminal 100 receives location information of the image forming apparatus 110 directly from the image forming apparatus 110 or from the service apparatus 130, which stores the location information of the image forming apparatus 110. The terminal 100 receives the location information of the image forming apparatus 110 in order to overlay an icon on a camera image in an accurate location of the image forming apparatus 110. The same method may be applied to the status information of the image forming apparatus 110. A system designer may set this, or a user or a manager of the image forming apparatus 110 may set a desired method. This may be referred to as a mode setting in the exemplary embodiment of the present general inventive concept.

The terminal 100 acquires the location information according to the following process. The terminal 100, the image forming apparatus 110, the service apparatus 130, and the navigation apparatus 140 may communicate with one another through the network 120. If the user executes the installed app, the terminal 100 acquires location information on its current location. If the terminal 100 transmits its current location to the service apparatus 130, the service apparatus 130 searches for an image forming apparatus 110 near the terminal 100 of the user, and transmits location information of the corresponding image forming apparatus 110 to the terminal 100. The app receives and executes the location information of the image forming apparatus 110, completes a virtual coordinate of the image forming apparatus 110 based on a location of the terminal 100, and requests status information of the image forming apparatus 110. In this case, if an authentication is required, the service apparatus 100 may transmit a list of image forming apparatuses 110 authorized to a user as user information of the app. After the terminal 100 receives the status information of the image forming apparatus 110, the terminal 100 receives the camera image and extracts camera view angle information of the user, current location information of the terminal 100, and up, down, left, and right direction information of the terminal 100. The terminal 100 displays an icon and a status information window of the image forming apparatus 110 according to a direction indicated by the terminal 100. Here, the icon and the status information window are overlaid on the camera image to be displayed on a real image.

If the service apparatus 130 is not included, and the user executes the app, the terminal 100 may receive a list and location information of all image forming apparatuses 110 on the same network as the terminal 100. For example, an image forming apparatus 110 which operates as a group owner may generate a list of peripheral image forming apparatuses 110 and provide the list to the terminal 100. The user of terminal 100 may then select from among the image forming apparatuses 110 on the same network as the terminal 100 and requests status information of the corresponding image forming apparatuses 110. After the terminal 100 receives the status information of the image forming apparatus 110, the terminal 100 receives the camera image and extracts the camera view angle information, the current location information of the terminal 110, and the up, down, left, and right direction information of the terminal 100. The terminal 100 displays icons and status information windows of the image forming apparatuses 110 according to a direction indicated by the terminal 100. Here, the icons and the status information windows of the image forming apparatuses 110 are overlaid on the camera image to be displayed on a real image.

The terminal 100 collects an operation status, abnormal information, and information about a residual amount of toner from a module of each set. For this purpose, the terminal 100 may include an additional searcher. Here, types of information collected by the set are as shown in Table 1 below.

TABLE 1

| Location Information | Status Information | Set Information |
|---|---|---|
| Latitude, Longitude, | Residual Amount of | Set ID, IP Address, |
| Altitude | Toner, Error Information | MAC, Model Name, |
| | (No paper, Jam, Network | Spec(capacity), etc. |
| | error, Device error, etc.), | |
| | Operation Status (In use, | |
| | on Standby), etc. | |

In more detail, if the terminal 100 operates along with the service apparatus 130, various types of status information of the image forming apparatus 110 are transmitted from the image forming apparatus 110 to the service apparatus 130 in real time. In other words, the image forming apparatus 110 periodically transmits information about a latitude, a longitude, an altitude, and an ID of itself, as well as information about a residual amount of toner, a status, and an Internet Protocol (IP) to the service apparatus 130. If the terminal 100 does not operate along with the service apparatus 130, the terminal 100 executes a printing app, performs a discovery, and requests status information of the searched image forming apparatus 110. The image forming apparatus 110 transmits the information about the latitude, longitude, altitude, and ID of the set, the residual amount of toner, the status, and the IP when the terminal 100 requests.

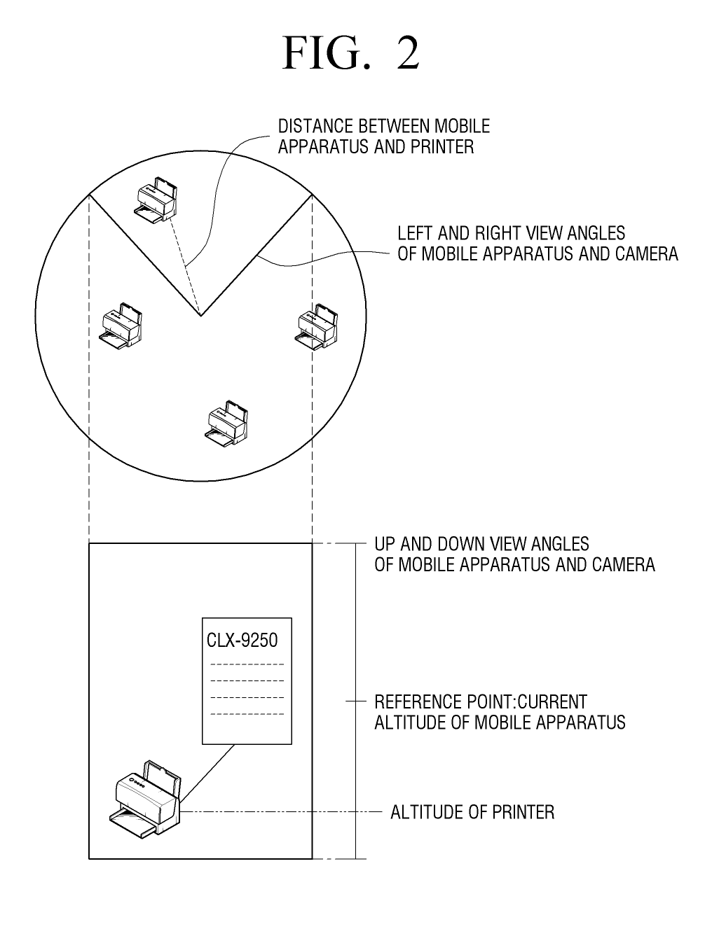

The status information of the image forming apparatus 110 is displayed on a UI of the terminal 100 as shown in FIG. 2. Here, the terminal 100 may display a user's authority to use the image forming apparatus 110 according to a security level. For example, a current location (a latitude, a longitude, or an altitude) of the terminal 100 is set as a reference point, and then a reference point of the image forming apparatus 110 is set. Left and right view angle values, and up and down view angle values of the camera are acquired to determine a currently displayed section of the screen, and a location of the image forming apparatus 110 is displayed in the currently displayed section of the screen. Only information of the image forming apparatus 110 within a radius is displayed on the screen, according to a distance between the terminal 100 and the image forming apparatus 110. Left and right coordinates of the image forming apparatus 110 are determined through information extracted from an electronic compass of the terminal 100. Up and down coordinates of the image forming apparatus 110 are determined through information extracted from a gyroscope sensor (hereinafter referred to as gyro sensor) of the terminal 100 according to a gradient of the terminal 110.

If the user clicks a status information box displayed on the UI, the terminal 100 changes a current screen to a screen which is to perform printing, copying, scanning, or faxing. If the user presses a print button, the terminal 110 immediately transmits a corresponding command to the image forming apparatus 110 to easily print contents of the terminal 100. The terminal 100 may also perform other scanning, copying, and faxing functions.

Examples of the image forming apparatus 110 include a printer, a copier, a fax machine, a scanner, and a multifunction peripheral (MFP) which realizes multiple functions through one device. The image forming apparatus 110 may operate in two types of modes. Here, the two types of modes are related to how the terminal 100 provides its location and status information, to display the icon of the image forming apparatus 110 on the image captured by the camera in the accurate location.

For example, a manager of the image forming apparatus 110 may set a mode through the service apparatus 130. In this case, the image forming apparatus 110 operates along with the service apparatus 130 to periodically transmit its location and status information to the service apparatus 130. The service apparatus 130 stores the location information and the status information periodically transmitted by the image forming apparatus 110 and provides the location information and the status information to the terminal 100. Here, since a location of the image forming apparatus 110 is changed or the residual amount of toner is frequently changed, the location information and the status information of the image forming apparatus 110 is periodically transmitted to inform the user of the terminal 100 about the change of the location of the image forming apparatus 110 or the change of the residual amount of toner.

The manager of the image forming apparatus 110 sets the terminal 100 as an information providing path. In this case, the image forming apparatus 110 performs a process of acquiring its own location information. The image forming apparatus 110 may acquire the location information by using three methods according to specs and the environment of where it is set up. The first method uses the navigation apparatus 140. In the first method, location information is received by using a GPS communication module of the image forming apparatus 110, and a Real Time Kinematic (RTK) method, such as a Virtual Reference Station (VRS) or a Flat Korrect Parameter (FKP), is used to increase accuracy. The image forming apparatus 110 including the GPS communication module periodically receives and stores its location information, which includes for example longitude, latitude, and altitude values. The second method uses a peripheral access point (AP) or sets an additional AP and uses an indoor positioning method using a triangulation method of a Wi-Fi signal to acquire the location information. The image forming apparatus 110 including a Wi-Fi module calculates its location based on positions and signal intensities of peripheral APs, and periodically stores longitude, latitude, and altitude values thereby calculated. The third method does not use an additional location sensor. Instead, in the third method, the image forming apparatus 110 is in a fixed location, and an installation manager manually inputs location information into the image forming apparatus 110. The location information is measured through a portable phone of the installation manager or an additional measurer and set in the image forming apparatus 110. The installation manager searches for a current location of the image forming apparatus 110 by using the portable phone and inputs longitude, latitude, and altitude values of the current location into the image forming apparatus 110.

As described above, the location information of the image forming apparatus 110, further, the status information, may be periodically transmitted to the service apparatus 130 or may be directly provided to the terminal 100 according to setting of the manager. This is described above in the description of the terminal 100 and thus will not be described further.

The communication network 120 may be any type of wired or wireless communication network. Here, a wired network includes the Internet such as a cable net or a Public Switched Telephone Network (PSTN), and a wireless network includes a Code Division Multiple Access (CDMA), a Wideband CDMA (WCDMA), a Global System/Standard for Mobile Communication (GSM), an Evolved Packet Core (EPC), a Long Term Evolution (LTE), a WiBro network, etc. Therefore, if the communication network 120 is a wired communication network, the terminal 100 may access a telephone exchange office to process data. If the communication network 120 is a wireless communication network, the terminal 100 may access a Serving GPRS Support Node (SGSN) or a Gateway GPRS Support Node (GGSN) operated by a communication company to process data or may access various types of repeaters, such as Base Station Transmission (BTS), NodeB, e-NodeB, or the like to process data. In other words, the terminal 100 processes the printing app of the terminal 100 and additional information related to the printing app.

If the terminal 100 depends on the service apparatus 130 to operate, and the terminal 100 transmits location information to the service apparatus 130, the service apparatus 130 searches for image forming apparatuses 110 near the terminal 100 based on the corresponding location information, and transmits location information of the searched image forming apparatuses 110 to the terminal 100. If the app of the terminal 100 receives the location information, the app calculates virtual coordinates of the nearby image forming apparatuses 110 based on a location of the terminal 100, and requests status information of each of the image forming apparatuses 110. The service apparatus 130 re-transmits status information to the terminal 100 to allow the terminal 100 to display an icon and status information of any of the image forming apparatuses 110 on an image captured by the camera.

The navigation apparatus 140 may be, for example, a GPS, and communicates with the terminal 100 and the image forming apparatus 110. If the navigation apparatus 140 includes a GPS communication module, the navigation apparatus 140 may communicate with the service apparatus 130. If the terminal 100 and the image forming apparatus 110 include GPS communication modules and are configured to acquire their location information by using the GPS communication modules, the terminal 100 and the image forming apparatus 110 communicate with the navigation apparatus 140 by using the GPS communication modules to check their locations and store information about the locations.

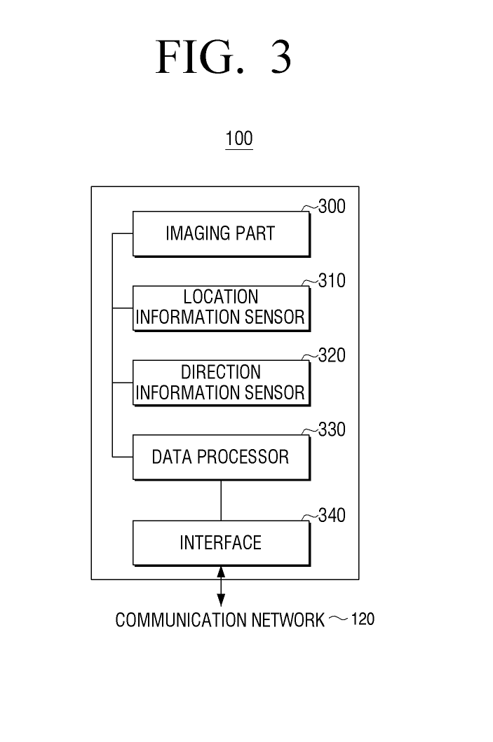

FIG. 3 is a block diagram illustrating a structure of the terminal 100 of FIG. 1, according to an exemplary embodiment of the present general inventive concept.

Referring to FIGS. 1 and 3, the terminal 100 includes parts or all of an imaging part 300, a location information sensor 310, a direction information sensor 320, a data processor 330, and an interface 340. Here, the data processor 330 may include a controller (not shown).

It will be understood that some elements may be omitted or may be integrated with other elements. The components are described separately herein to convey a sufficient understanding of the present general inventive concept.

The imaging part 300 includes a camera. The imaging part 300 provides an image captured through the camera to the data processor 330.

The location information sensor 310 includes a location sensor or a GPS communication module, a Wi-Fi module, etc. to acquire location information on the terminal by using the navigation apparatus 140 or a peripheral AP. Alternatively, the location information sensor 310 may acquire the location information of the terminal 100 from the service apparatus 130.

The direction information sensor 320 includes a direction sensor, such as a gyroscope sensor, etc. Through this sensor, the direction information sensor 320 senses a direction in which the imaging part 300 is aimed, and the direction information sensor overlays an icon of the image forming apparatus 110 positioned within a view angle of the imaging part 300.

The data processor 330 includes a controller. The data processor 330 receives at least one of location information and status information of the image forming apparatus 110 directly from the image forming apparatus 110 through the communication network 120 or indirectly through the service apparatus 130 and maps the at least one information with an image captured by the imaging part 300. The mapped image may be displayed on the interface 340, e.g. on a display.

The interface 340 includes a communication interface and a UI. Here, the communication interface processes a signal or data processed by the data processor 330 and transmits the processed signal or data to the communication network 120. The UI may include a button part or the display. The button part may receive a command of a user. The display may display a button through which the user command is received or may overlay an icon and a status information window of the image forming apparatus 110 on the image captured by the imaging part 300.

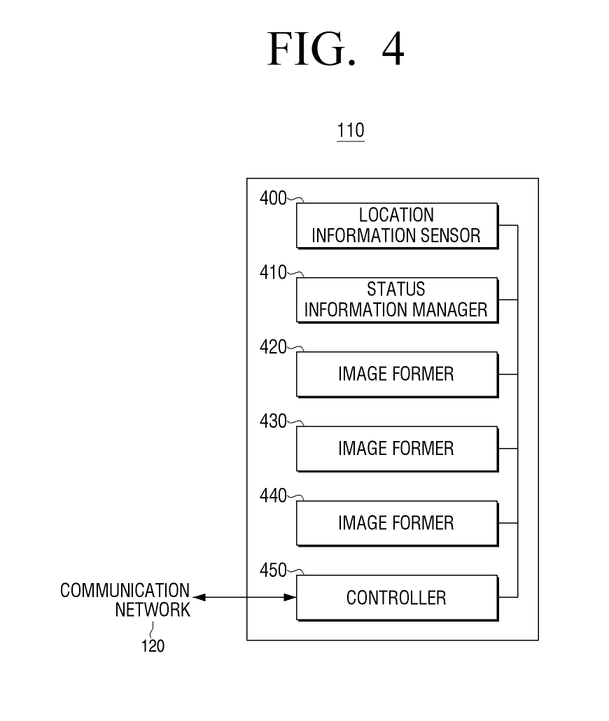

FIG. 4 is a block diagram illustrating a structure of the image forming apparatus 110 of FIG. 1, according to an exemplary embodiment of the present general inventive concept.

Referring to FIGS. 1 and 4, the image forming apparatus 110 according to the present exemplary embodiment includes some or all of a location information sensor 400, a status information manager 410, image formers 420, 430, and 440, and a controller 450.

The location information sensor 400 includes a location sensor which receives location information using a GPS and Wi-Fi-based location information or location information manually input by an installer. The image forming apparatus 110 may acquire location information through the location sensor.

The status information manager 410 periodically performs an operation of acquiring and storing status information, e.g. a status of the image forming apparatus 110, a network status, and a residual amount of toner.

The image formers 420, 430, and 440 may include for example a printer, a scanner, and a fax machine. The printer prints input data as a printout, the scanner copies input image data, and the fax machine transmits the input data to an external apparatus. Alternatively the image formers 420, 430, and 440 may comprise for example the components of an MFP. The image forming apparatus 110 includes at least one of the image formers 420, 430, and 440 and performs a corresponding image forming operation when an icon displayed on the terminal 100 is selected.

The controller 450 operates if there is a control command of a user, and controls an overall operation of the image forming apparatus 110. In other words, the controller 450 controls operations of the location information sensor 400 and the status information manager 410. For example, if there is a selection by the user of an icon on the terminal 100, the controller 450 controls the image forming apparatus 110 to perform an operation, such as printing, scanning, faxing, or the like, corresponding to the selected icon.

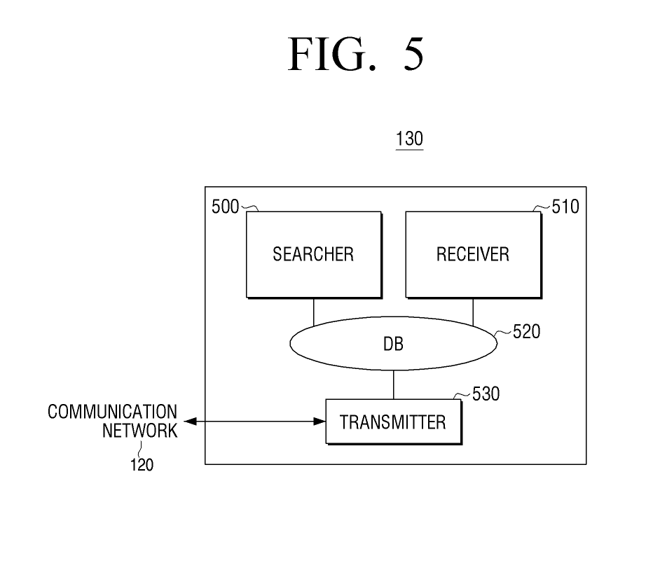

FIG. 5 is a block diagram illustrating a structure of the service apparatus 130 of FIG. 1, according to an exemplary embodiment of the present general inventive concept.

Referring to FIGS. 1 and 5, the service apparatus 130 according to the present exemplary embodiment includes some or all of a searcher 500, a receiver 510, a DB 520, and a transmitter 530. The service apparatus 130 may further include a controller (not shown). Here, the transmitter 530 may perform a role of the controller which processes data, or the searcher 500 may perform the role of the controller. The receiver 510 may be referred to as a status information manager.

The searcher 500 receives location information of the terminal 100 and periodically searches for an image forming apparatus 110 near the terminal 100 based on the received location information. For example, the searcher 500 searches nearby image forming apparatuses 110 based on latitude, longitude, and altitude values and transmits current statuses of the corresponding image forming apparatuses 110 to the terminal 100. A method of searching for nearby image forming apparatuses 110 is as follows. If the distance defined as “nearby” is 10 m based on a latitude, a longitude, and altitude of the terminal 100, the searcher 500 searches for image forming apparatuses 110 whose linear distance from the terminal 100, considering latitude, longitude, and altitude values of the image forming apparatus 110, is in a range of about 10 m. Therefore, the searcher 500 may include an additional comparator.

The receiver 510 operates along with the image forming apparatus 110, along with the image forming apparatus 110 under control of the controller, to request status information and receive requested status information.

The DB 520 matches and stores various types of information, such as apparatus information and location information of the image forming apparatus 110 and status information corresponding to the apparatus information. The DB 520 outputs corresponding information according to requests of the searcher 500 and the receiver 510.

The transmitter 530 transmits the search result of the searcher 500 to the terminal 100, further, provides the terminal 100 with status information provided from the receiver 510 or provided after searching for the DB 520.

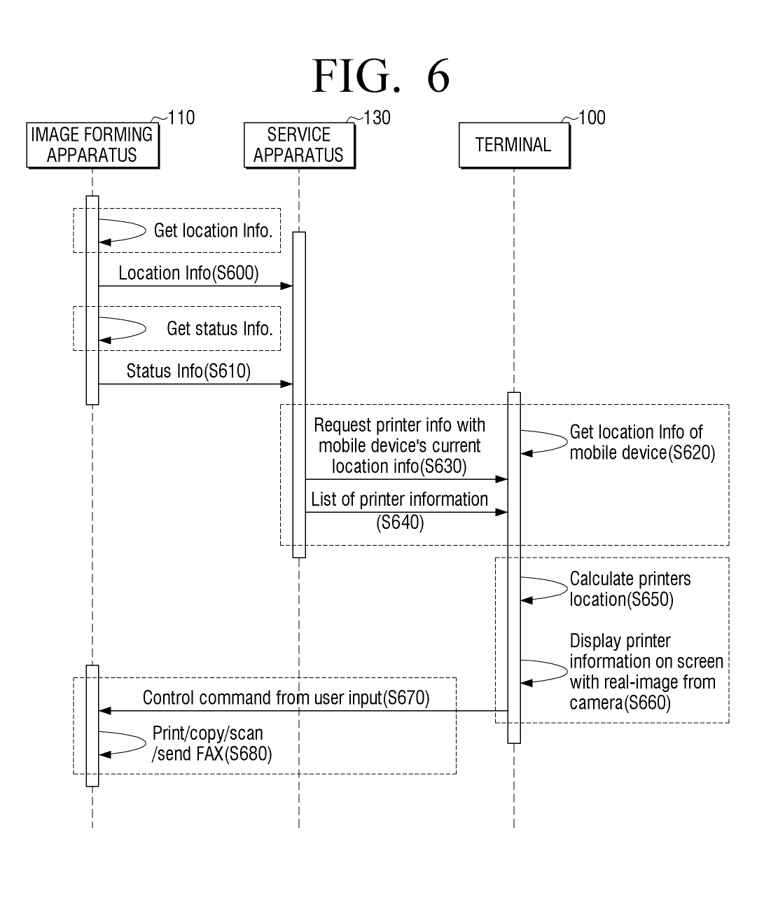

FIG. 6 is a flowchart illustrating a process of forming an image according to an exemplary embodiment of the present general inventive concept. The terminal 100 may be a mobile apparatus such as a portable phone or the like, and the image forming apparatus 110 may be a printer, as indicated in FIG. 6.

Referring to FIGS. 1 and 6, the image forming apparatus 110 acquires location information and transmits the location information to the service apparatus 130 in operation S600. Likewise, the image forming apparatus 110 acquires status information thereof and transmits the status information to the service apparatus 130 in operation S610. For this purpose, the image forming apparatus 110 may communicate with a GPS satellite or perform a near field communication with a peripheral AP to acquire location information according to a triangulation by using a signal intensity or the like. Also, the controller may check each set to acquire status information.

In operation S620, the terminal 100 acquires location information of a mobile device and transmits the location information to the service apparatus 130. In operation S630, the service apparatus 130 searches the peripheral image forming apparatuses 110 based on the corresponding location information to provide location information of the searched image forming apparatuses 110 to the terminal 100. Alternatively, in operation S640, the service apparatus 130 may transmit list information of the location information to the terminal 100.

In operation S650, the terminal 100 calculates a location of the terminal 100 relative to the image forming apparatus 110 by using the location information of the image forming apparatus 100.

In operation S660, the terminal 100 displays an icon and status information of the image forming apparatus 110 in a location of a relative coordinate calculated from an image captured through the camera.

In operation S670, the terminal 100 receives a control command from a user, such as the user clicking a status information box on a UI in order to change a current screen to a screen which is to perform printing, copying, scanning, or faxing. In operation S680, the selected operation of printing, copying, scanning, or faxing is carried out.

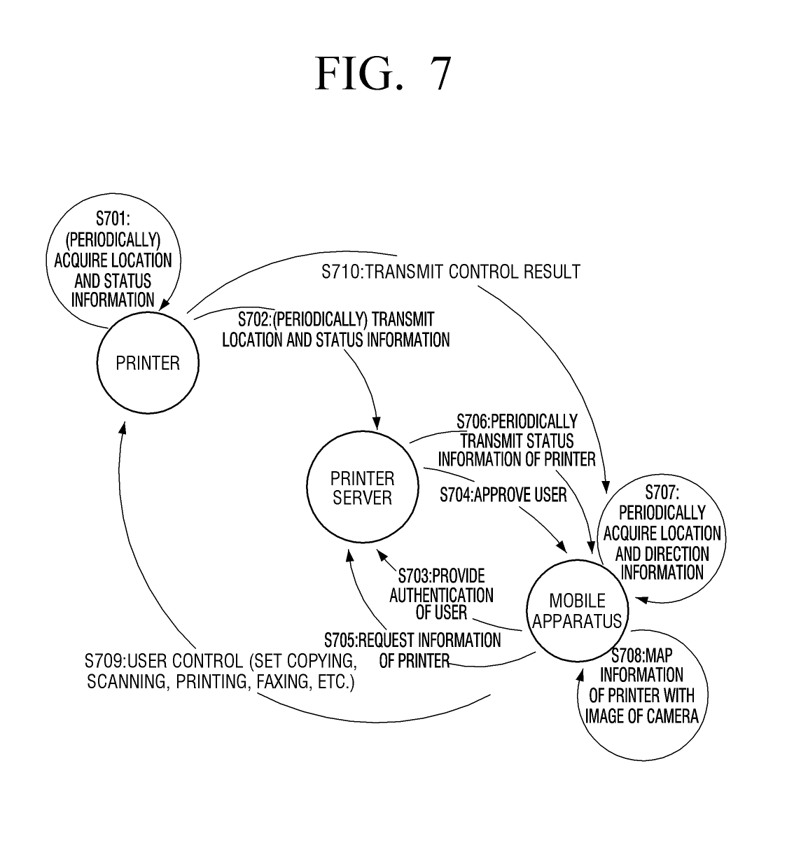

In the above-described process, if the terminal 100 requests information about the image forming apparatus 110, the service apparatus 130 may perform an additional authentication process and provide the information. Therefore, the present exemplary embodiment is not particularly limited thereto. This is illustrated in greater detail in FIG. 7.

FIG. 7 is a view illustrating the process of FIG. 6. Here, the terminal 100 may be a mobile apparatus such as a portable phone or the like, and the image forming apparatus 110 may be a printer, as indicated in FIG. 7 and referred to herein.

As seen in FIG. 7, the image forming apparatus 110 periodically acquires location and status information in operation S701, and periodically transmits this information to a printer server in operation S702. User authentication is provided in operation S703, and approval of the user is given in operation S704. After this approval, the mobile apparatus may request printer information in operation S705, and the printer server periodically transmits the status information of the printer in operation S706. The mobile apparatus periodically acquires the printer's location and direction information from the printer in operation S707, and maps information of the printer with an image provided by a camera in operation S708. In operation S709, the printer receives a user control input, for example a command to start an image forming operation. The printer transmits the result of this operation back to the mobile apparatus in operation S710.

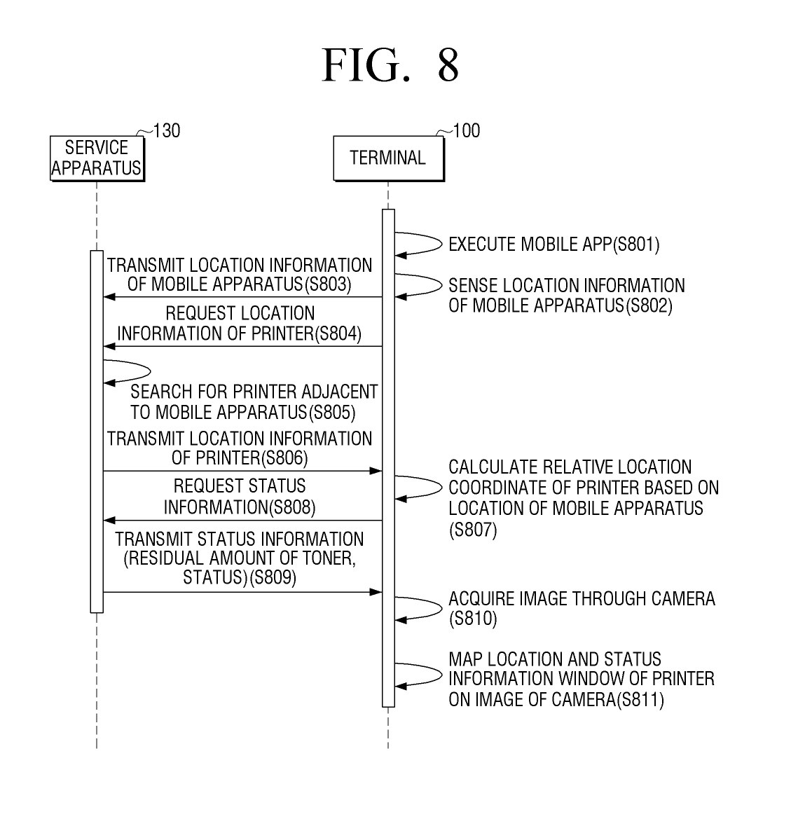

FIG. 8 is a flowchart illustrating operations performed between the terminal 100 and the service apparatus 130, according to an exemplary embodiment of the present general inventive concept. The terminal 100 may be a mobile apparatus such as a portable phone or the like, and the image forming apparatus 110 may be a printer, as indicated in FIG. 8 and referred to hereinbelow.

Referring to FIGS. 1 and 8, in operation S801, the terminal 100 executes a mobile app to realize an augmented reality (AR) technology for the nearby image forming apparatus 110.

In operations S802 and S803, the terminal 100 senses location information of the mobile apparatus and transmits the sensed location information to the service apparatus 130. In operation S804, the terminal 100 requests location information of the printer, i.e., the image forming apparatus 110.

In operation S805 and S806, the service apparatus 130 searches for a nearby printer based on the location information of the mobile apparatus and provides the search result to the terminal 100.

In operation S807, the terminal 100 calculates a relative location of the printer based on a location of the mobile apparatus.

In operations S808 and S809, the terminal 100 requests status information of the printer from the service apparatus 130 and receives the requested status information.

In operations S810 and S811, the terminal 100 acquires an image through the camera and maps a location and status information of the printer on the acquired image.

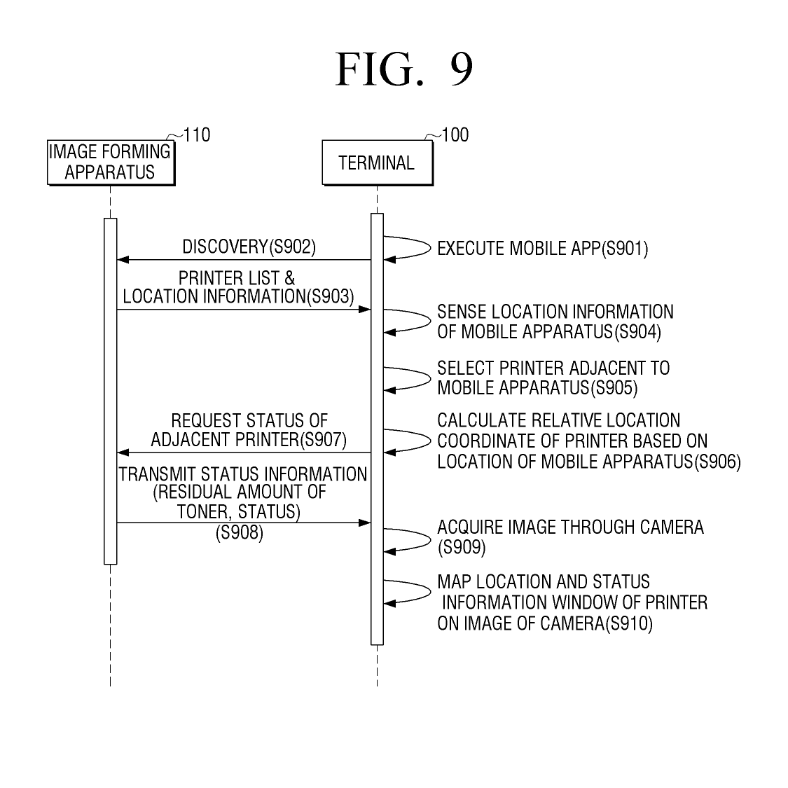

FIG. 9 is a flowchart illustrating operations performed between the terminal 100 and the image forming apparatus 110, according to an exemplary embodiment of the present general inventive concept. Here, the terminal 100 may be a mobile apparatus such as a portable phone or the like, and the image forming apparatus 110 may be a printer, as indicated in FIG. 9 and referred to hereinbelow.

Referring to FIGS. 1 and 9, if the terminal 100 does not operate along with the service apparatus 130 to realize an AR technology, the terminal 100 executes a mobile app to communicate with the image forming apparatus 110 which may operate as an adjacent group owner in operation S901. The terminal 100 performs a discovery of image forming apparatuses 110 in operation S902.

In operation S903, the terminal 100 receives location information or list information about nearby image forming apparatuses 110 from the image forming apparatus 110.

In operations S904 and S905, the terminal 100 as the mobile apparatus senses its location to acquire its location information and selects nearby printers based on the acquired location information.

In operation S906, the terminal 100 calculates relative location coordinates of printers based on the location of the mobile apparatus. This calculation can be limited to a particular distance. If for example the terminal 100 is set to select printers within a range of about 10 m, the terminal 100 calculates relative location coordinates of only the printers within the range of about 10 m in operation S906.

In operations S907 and S908, the terminal 100 requests status information of the nearby printers and receives the requested status information.

In operations S909 and S910, the terminal 100 acquires an image captured through the camera and maps icons and status information of the printers on the acquired image.

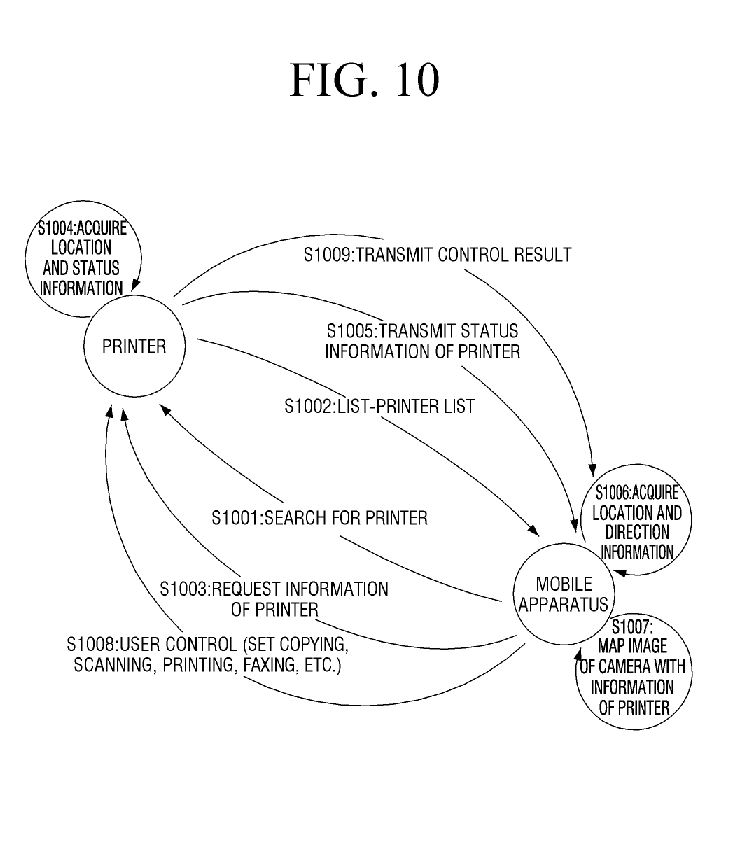

Even in the above-described operations, a user of the terminal 100 may select a desired printer to additionally perform functions including copying, faxing, scanning, etc. as shown in FIG. 10.

FIG. 10 is a view illustrating a data flow if the service apparatus 130 of FIG. 1 is not used. Here, the terminal 100 may be a mobile apparatus such as a portable phone or the like, and the image forming apparatus 110 may be a printer, as indicated in FIG. 10 and referred to herein.

As seen in FIG. 10, a mobile apparatus searches for a printer in operation S1001. The printer provides a list of available printers in operation S1002. The mobile apparatus requests information of a printer in operation S1003, and the printer accordingly acquires location and status information in operation S1004. In operation 1005, the printer transmits its status information to the mobile apparatus, which in turn acquires its own location and direction information in operation S1006. A camera image is mapped with information of the printer in operation S1007. In operation 1008, the printer receives a user control, which may be for example a command to start an image forming process such as copying, scanning, printing, or faxing. The printer transmits the result of this process to the mobile apparatus in operation S1009.

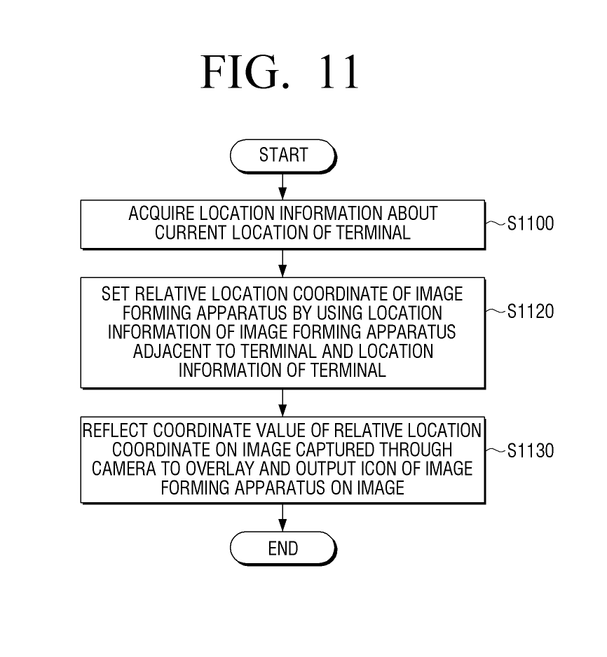

FIG. 11 is a flowchart illustrating an image forming method according to an exemplary embodiment of the present general inventive concept.

Referring to FIGS. 1 and 11, in operation S1100, the terminal 100 according to the present exemplary embodiment acquires location information about its current location. For this purpose, the terminal 100 may operate a location sensor to execute a mobile app in order to acquire the location information. This process of acquiring location information is described above and thus is not described herein.

In operation S1120, the terminal 100 sets a relative location coordinate of the image forming apparatus 110 based on the terminal 100 by using location information of the nearby image forming apparatus 110 and the location information of the terminal 100. In other words, the terminal 100 may calculate a relative distance.

In operation S1130, the terminal 100 overlays an icon of the image forming apparatus 110 on an image captured through an imaging part, e.g., a camera, based on a coordinate value, i.e., a distance.

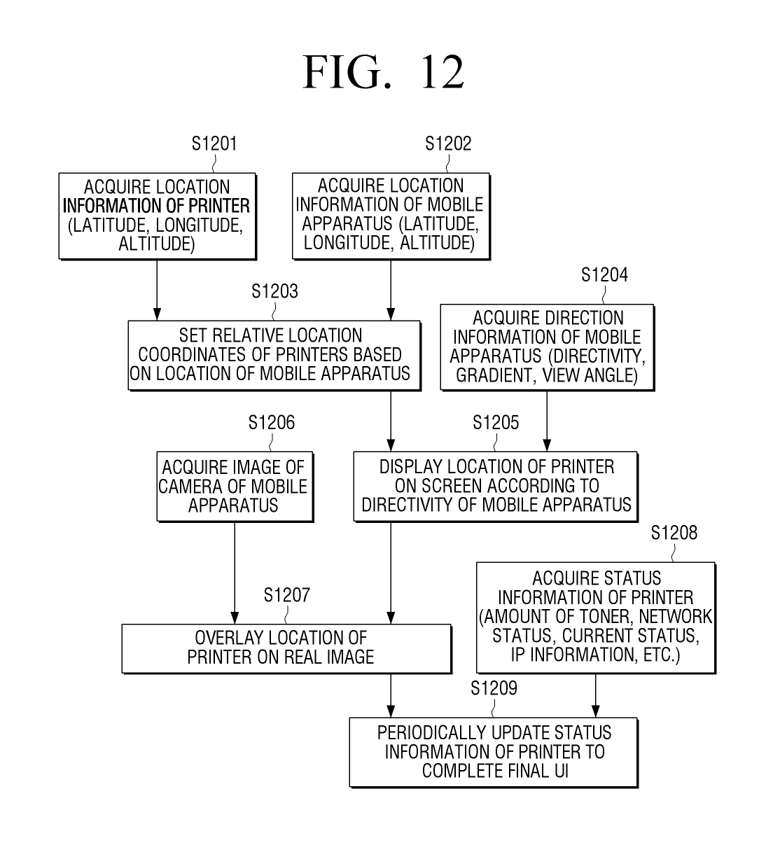

FIG. 12 is a flowchart illustrating an image forming method according to another exemplary embodiment of the present general inventive concept. Here, the terminal 100 may be a mobile apparatus such as a portable phone or the like, and the image forming apparatus 110 may be a printer, as indicated in FIG. 12 and referred to hereinbelow.

Referring to FIGS. 1 and 12, in operation S1201, the terminal 100 as a mobile apparatus acquires location information of nearby printers, either from the printers themselves or through an additional server. In operation S1202, the terminal 100 as a mobile apparatus acquires location information of itself.

In operation S1203, the terminal 100 sets (or calculates) relative location coordinates of printers based on a location of the terminal by using the acquired two pieces of location information.

In operations S1204 and S1205, the terminal 100 acquires direction information of the mobile apparatus and displays the location of the printer according to a directivity of the mobile apparatus.

In operations S1206 and S1207, the terminal 100 acquires an image through a camera, and overlays and displays an icon on the acquired image based on a location of the printer.

In operations S1208 and S1209, the terminal 100 acquires status information of the printer and periodically updates the status information to complete and display a final UI for a user. As described above, if the terminal 100 directly communicates with a nearby printer, the terminal 100 may acquire status information from the nearby printer. If the terminal 100 operates along with an additional server, the terminal 100 may acquire the status information from the additional server.

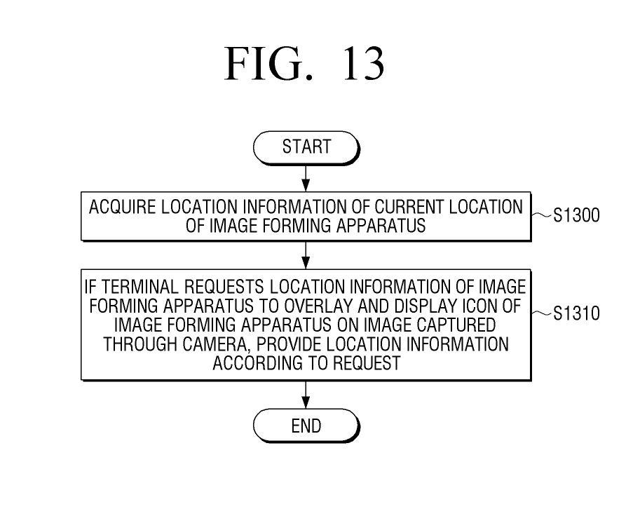

FIG. 13 is a flowchart illustrating a method of driving the image forming apparatus 110 of FIG. 1, according to an exemplary embodiment of the present general inventive concept.

Referring to FIGS. 1 and 13, if the image forming apparatus 110 according to the present exemplary embodiment executes a mobile app in the terminal 100 to operate along with the terminal 100, the image forming apparatus 110 acquires location information about a current location of itself in operation S1300.

If the image forming apparatus 110 requests location information directly from the terminal 100 or indirectly from the service apparatus 130, the image forming apparatus 110 provides the acquired location information to the terminal 100 in operation S1310. Therefore, the image forming apparatus 110 displays an icon of the image forming apparatus 110 on an image captured through a camera.

In the above-described process, if the image forming apparatus 110 requests status information directly from the terminal 100 or indirectly from the service apparatus 130, the image forming apparatus 110 provides the corresponding status information.

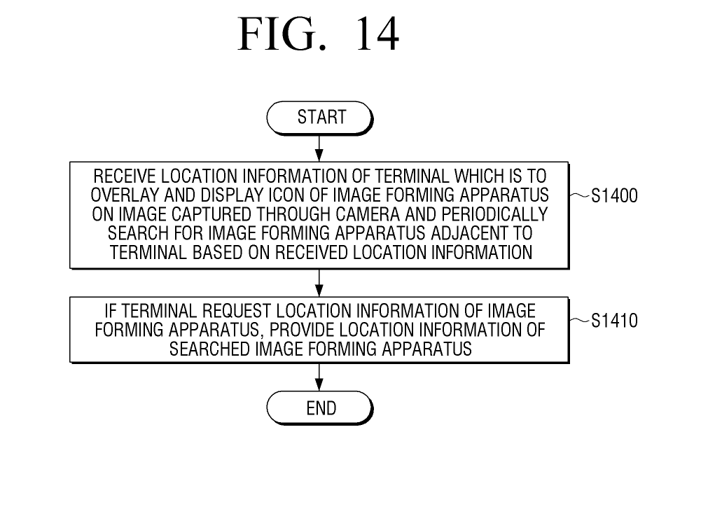

FIG. 14 is a flowchart illustrating a method of driving the service apparatus 130 of FIG. 1, according to an exemplary embodiment of the present general inventive concept.

Referring to FIGS. 1 and 14, in operation S1400, the service apparatus 130 according to the present exemplary embodiment receives location information from the terminal 100 and periodically searches for the image forming apparatuses 110 located near the terminal 100 based on the received location information. For example, since the image forming apparatus 110 may be moved, the image forming apparatus 110 may be searched for at predetermined time intervals.

If the terminal 100 requests location information of the image forming apparatus 110, the service apparatus 130 provides the corresponding location information in operation S1410.

The service apparatus 130 may perform various types of operations. For example, the service apparatus 130 may calculate a relative coordinate value of the image forming apparatus 110 based on location information of the terminal 100, map the relative coordinate value on a calculated distance to generate an image displaying an icon of the image forming apparatus 110, and provide the image to the terminal 100. Also, the terminal 100 may only receive and display the image. Therefore, the present general inventive concept is not particularly limited to the above-described contents.

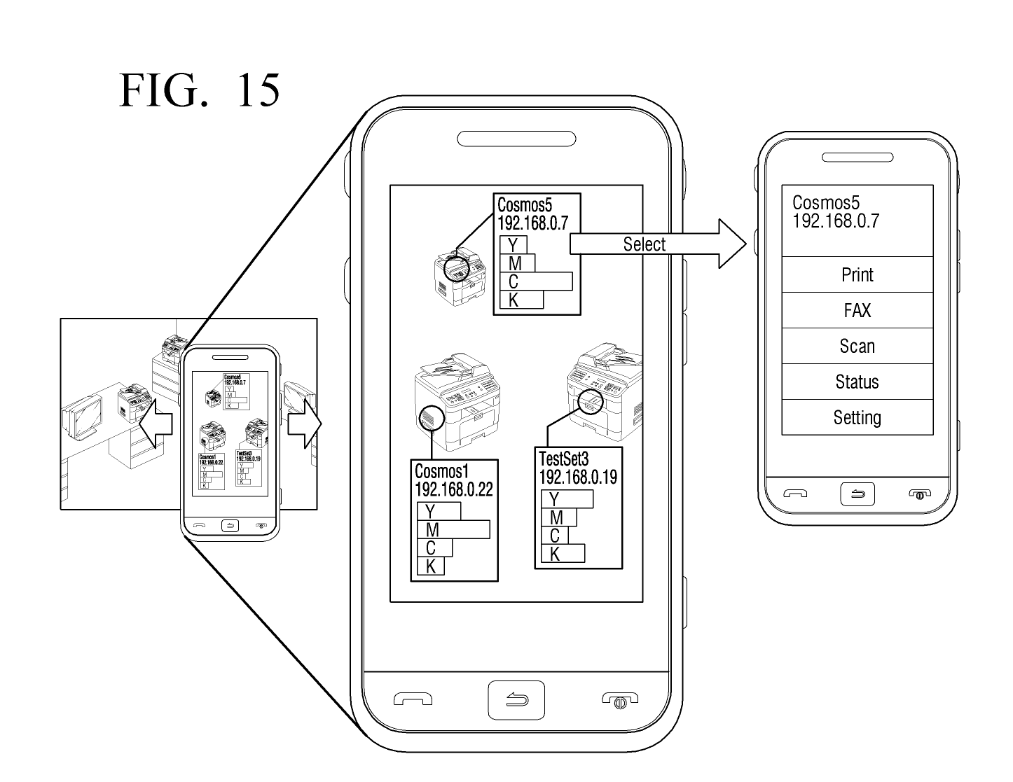

FIG. 15 is a view illustrating a screen embodied in the terminal 100 of FIG. 1, according to an exemplary embodiment of the present general inventive concept.

Referring to FIGS. 1 and 15, when a user of the terminal 100 aims a camera of the terminal, an image within a predetermined range is acquired, and an icon of the image forming apparatus 110 within the predetermined range is overlaid on the image and displayed on the screen.

Here, the terminal 100 displays the icon of the image forming apparatus 110 along with status information of the image forming apparatus 110, e.g., a residual amount of toner or an operation state.

If the user clicks the corresponding icon, the terminal performs an additional operation such as printing, faxing, scanning, or the like.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A terminal comprising:
a location information sensor which acquires location information about a current location of the terminal;
a data processor which receives location information of a nearby image forming apparatus based on the current location of the terminal and calculates a relative location coordinate of the nearby image forming apparatus by using the received location information of the nearby image forming apparatus and the acquired location information of the current location of the terminal; and
an interface which overlays and outputs an icon of the nearby image forming apparatus on an image captured through an imaging part, based on a coordinate value of the calculated relative location coordinate.

2. The terminal of claim 1, further comprising:
a searcher which searches for the image forming apparatus,
wherein the data processor receives location information about the searched image forming apparatus.

3. The terminal of claim 1, further comprising:
a direction information sensor which acquires direction information of the terminal,
wherein the interface overlays the icon on the image by additionally using the direction information.

4. The terminal of claim 1, wherein the data processor receives location information stored in the image forming apparatus or location information provided when accessing an external service apparatus which stores location information of the image forming apparatus.

5. The terminal of claim 1, wherein the interface includes and outputs status information of the image forming apparatus in the icon.

6. An image forming apparatus comprising:
a location information sensor which acquires location information about a current location of the image forming apparatus; and
a controller which, if a terminal requests the location information to overlay and display an icon of the image forming apparatus on an image captured through an imaging part, controls the location information sensor to provide the location information according to the request.

7. The image forming apparatus of claim 6, further comprising:
a status information manager which stores status information of the image forming apparatus and provides the status information according to a request of the terminal.

8. The image forming apparatus of claim 7, wherein the status information manager stores at least one of a residual amount of toner, error information, and an operation status as the status information of the image forming apparatus.

9. The image forming apparatus of claim 7, wherein the controller periodically checks a status of the image forming apparatus to update the status information stored in the status information manager.

10. The image forming apparatus of claim 6, wherein the location information sensor includes a global positioning system (GPS) communication module which is to communicate with a GPS, and
wherein the location information sensor periodically checks the location information of the image forming apparatus through the GPS communication module.

11. The image forming apparatus of claim 6, wherein the location information sensor includes a near field communication module which is to communicate with nearby access points (APs), and
wherein the location information sensor measures the nearby APs according to a triangulation by using locations and signal intensities of the nearby APs acquired through the near field communication module to acquire the location information.

12. An image forming method of a terminal, the image forming method comprising:
acquiring location information about a current location of the terminal;
receiving location information of an image forming apparatus near the terminal and calculating a relative location coordinate of the image forming apparatus by using the location information of the image forming apparatus and the location information of the terminal;
acquiring an image through an imaging part of the terminal; and
overlaying and outputting an icon of the image forming apparatus on the acquired image based on a coordinate value of the calculated relative location coordinate.

13. The image forming method of claim 12, further comprising:
searching for the image forming apparatus,
wherein the location information of the image forming apparatus is received to calculate the relative location coordinate.

14. The image forming method of claim 12, further comprising:
acquiring direction information of the terminal,
wherein the icon is overlaid on the acquired image by additionally using the direction information.

15. The image forming method of claim 12, wherein location information stored in the image forming apparatus is received or an external service apparatus storing the location information of the image forming apparatus is accessed to receive location information in order to calculate the relative location coordinate.

16. The image forming method of claim 12, wherein the overlaying of the icon includes: including and outputting status information of the image forming apparatus in the icon.

17. A method of driving an image forming apparatus, the method comprising:
acquiring location information about a current location of a location information sensor; and
if a terminal requests the location information to overlay and display an icon of the image forming apparatus on an image acquired through an imaging part, controlling the location information sensor to provide the location information according to the request.

18. The method of claim 17, further comprising:
storing status information of the image forming apparatus in a status information storage and providing the stored status information according to a request of the terminal.

19. The method of claim 18, wherein the status information storage stores at least one of a residual amount of toner, error information, and an operation status as the status information of the image forming apparatus.

20. The method of claim 18, wherein a controller periodically checks a status of the image forming apparatus to update the status information stored in the status information storage.

21. The method of claim 17, wherein the location information sensor communicates with a GPS by using a GPS communication module, and
wherein the location information sensor periodically checks the location information of the image forming apparatus, which is changed, through the GPS communication module.

22. The method of claim 17, wherein the location information sensor communicates nearby APs by using a near field communication module,
wherein the location information sensor measures the nearby APs according to a triangulation by using locations and signal intensities of the nearby APs acquired through the near field communication module to acquire the location information.

23. A non-transitory computer-readable recording medium comprising a program to execute the image forming method of claim 12.
